(19) United States
(12) Patent Application Publication
(10) Pub. No.: US 2024/0280673 A1
(43) Pub. Date: Aug. 22, 2024

(54) SENSOR FOR ACQUIRING A DEPTH MAP OF A SCENE

(71) Applicant: Commissariat à l'Énergie Atomique et aux Énergies Alternatives, Paris (FR)

(72) Inventors: Gaelle Palmigiani, Grenoble Cedex 9 (FR); Yvon Cazaux, Grenoble Cedex 9 (FR); Alexis Rochas, Grenoble Cedex 9 (FR); Francois Ayel, Grenoble Cedex 9 (FR)

(73) Assignee: Commissariat à l'Énergie Atomique et aux Énergies Alternatives, Paris (FR)

(21) Appl. No.: 18/571,205

(22) PCT Filed: Jun. 16, 2022
(86) PCT No.: PCT/EP2022/066448

§ 371 Date: Dec. 15, 2023

(30) Foreign Application Priority Data
Jun. 21, 2021 (FR) FR2106576

(51) Int. Cl. G01S 7/481; G01S 7/4914; G01S 7/4915; G01S 17/32; G01S 17/894

(52) U.S. Cl. CPC G01S 7/4816; G01S 7/4914; G01S 7/4915; G01S 17/894; G01S 17/32

(57) ABSTRACT

A sensor of a reflected light signal for acquiring a depth map of the scene. Each depth pixel of the sensor includes at least one pair of photosites. Each pair of photosites incudes a first photosite of a first semiconductor substrate and a second photosite of a second substrate having the first substrate stacked thereon. Each pixel is configured to acquire, for each pair of photosites of the pixel, at least one sample of charges simultaneously photogenerated in photosensitive elements of the photosites of said pair.

The present application is based on, and claims the priority of, French patent application 21/06576 filed on Jun. 21, 2021 and entitled “Sensor for acquiring a depth map of a scene”, which is incorporated herein by reference to the maximum extent allowable by law.

### TECHNICAL FIELD

The present application concerns the field of sensors for acquiring a depth map, or image, of a scene.

### PRIOR ART

Image acquisition sensors capable of acquiring depth information have been provided. For example, indirect time-of-flight (iTOF) sensors act to emit a light signal towards a scene, and then to detect the light signal reflected by objects of the scene. By the evaluation of the phase shift between the emitted light signal and the reflected light signal, it is possible to estimate distances between the sensor and elements, for example objects, of the scene, or relative distances (depths) between elements of the scene.

### SUMMARY OF THE INVENTION

There is a need to have a depth image sensor overcoming all or part of the disadvantages of known depth image sensors.

For example, it is desirable to have a high-resolution depth image sensor of reduced dimensions.

For example, it would be desirable to have a depth image sensor having a same resolution and same lateral dimensions as a conventional depth image sensor, but with an increased sensitivity as compared with this conventional sensor.

An embodiment overcomes all or part of the disadvantages of known depth image sensors.

An embodiment provides a sensor of a reflected light signal corresponding to the reflection on a scene of a periodically amplitude-modulated incident light signal for acquiring a depth map of the scene, the sensor comprising depth pixels, wherein:
each depth pixel comprises at least one pair of photosites, each photosite corresponding to a single photosensitive element and an assembly of components enabling to acquire at least one sample of charges photogenerated by absorption by this photosensitive element of the reflected light signal;
   each pair of photosites comprises a first photosite comprising a first photosensitive element arranged in a first semiconductor substrate and a second photosite comprising a second photosensitive element arranged in a second semiconductor substrate having the first semiconductor substrate stacked thereon; and each depth pixel is configured to acquire:
      at least one first sample of charges photogenerated in the first and second photosensitive elements of a first pair of photosites of said pixel by detection of the light signal reflected during first time periods;
      at least one second sample of charges photogenerated in the first and second photosensitive elements of a second pair of photosites of said pixel by detection of the reflected light signal during second time periods offset with respect to the first time periods by a first constant phase shift; and
      at least one third sample of charges photogenerated in the first and second photosensitive elements of a third pair of photosites of said pixel by detection of the light signal reflected during third time periods offset with respect to the first time periods by a second constant phase shift different from the first phase shift,
   wherein the acquisition of a sample of charges photogenerated during a given time period in a pair of first and second photosites corresponds to the acquisition of the charges photogenerated in the first photosite during said given time period and to the simultaneous acquisition of the charges photogenerated in the second photosite during the same given time period.

According to an embodiment, each first photosensitive element of each depth pixel is stacked on a second photosensitive element, preferably of said pixel.

According to an embodiment, each depth pixel comprises as many first photosensitive elements as second photosensitive elements.

According to an embodiment, in each depth pixel, the first and third pairs of photosites have the same first photosite and the same second photosite. In other words, the first and third pairs of photosites are one and the same. Still in other words, the first photosite of the first pair of photosites is implemented by the first photosite of the third pair of photosites, the second photosite of the first pair being implemented by the second photosite of the third pair.

According to an embodiment, each depth pixel is further configured to acquire at least one fourth sample of charges photogenerated in the first and second photosensitive elements of a fourth pair of photosites of said pixel by detection of the light signal reflected during fourth time periods offset with respect to the first time periods by a third constant phase shift different from the first and second phase shifts.

According to an embodiment, in each depth pixel, the second and fourth pairs of photosites have a same first photosite and a same second photosite. In other words, the second and fourth pairs of photosites are one and the same. Still in other words, the first photosite of the second photosite pair is implemented by the first photosite of the fourth pair of photosites, the second photosite of the second photosite pair being implemented by the second photosite of the fourth pair.

According to an embodiment, in each pair of photosites of each depth pixel, the first photosensitive element of the first photosite of said pair is stacked on the second photosensitive element of the second photosite of said pair.

According to an embodiment:
the first and second photosites of the depth pixels are organized in rows and in columns; and in each depth pixel, the first photosite of each pair of photosites of said pixel is offset by one row and/or by one column with respect to the second photosite of said pair of photosites.

According to one embodiment:
each first photosite comprises a first node and at least one first sampling circuit arranged inside and on top of the first substrate and coupling the first node to the first photosensitive element of the first photosite; and
each second photosite comprises a second node and at least one second sampling circuit arranged inside and on top of the second substrate and coupling the second node to the second photosensitive element of the second photosite.

According to an embodiment:
each first photosite comprises a first output circuit coupling the first node of the first photosite to a first output line of the first photosite; and
each second photosite comprises a second output circuit coupling the second node of the second photosite to a second output line of the second photosite.

According to an embodiment, in each pair of photosites, the second node of the second photosite is directly connected to the first node of the first photosite.

According to an embodiment, in each pair of photosites, the first output line of the first photosite is directly connected to the second output line of the second photosite.

According to an embodiment, the sensor comprises a digital processing circuit configured to add, by digital processing, for each pair of photosites, the charges photogenerated in the first photosensitive element of the first photosite of said pair and the charges photogenerated in the second photosensitive element of the second photosite of said pair.

According to an embodiment, the sensor further comprises 2D image pixels arranged on top and inside of one and/or other of the first and second substrates.

According to an embodiment, the sensor further comprises a control circuit configured, for each pair of photosites of each pixel, to identically and simultaneously control the first and second photosites of said pair of photosites.

An embodiment provides a system for acquiring a depth image comprising the described sensor, a light source configured to emit the periodically amplitude-modulated incident light signal, and a processor configured to determine, based on the first, second, and third samples, a phase shift between the incident light signal and the reflected light signal.

According to an embodiment, each depth pixel of the sensor is configured to acquire at least one fourth sample of charges photogenerated in the first and second photosensitive elements of a fourth pair of photosites of said pixel by detection of the light signal reflected during fourth time periods offset with respect to the first time periods by a third constant phase shift different from the first and second phase shifts, and the processor is configured to determine, based on the first, second, third, and fourth samples, the phase shift between the incident light signal and the reflected light signal.

### BRIEF DESCRIPTION OF THE DRAWINGS

The foregoing features and advantages, as well as others, will be described in detail in the rest of the disclosure of specific embodiments given by way of illustration and not limitation with reference to the accompanying drawings, in which:

FIG. 1 schematically shows an embodiment of a depth imaging system;

FIG. 2 is a graph illustrating an example of light intensity of a light signal emitted and reflected according to an embodiment;

FIG. 3 is a partial and simplified cross-section view of a depth image acquisition device;

FIG. 4 shows a circuit diagram illustrating an embodiment of a pair of photosites of the device of FIG. 3;

FIG. 5 shows a circuit diagram illustrating another embodiment of a pair of photosites of the device of FIG. 3;

FIG. 6 shows a circuit diagram illustrating still another embodiment of a pair of photosites of the device of FIG. 3;

FIG. 7 shows a circuit diagram illustrating still another embodiment of a pair of photosites of the device of FIG. 3;

FIG. 8 schematically shows an embodiment of an arrangement of photosites of a depth pixel;

FIG. 9 schematically shows another embodiment of an arrangement of photosites of a depth pixel;

FIG. 10 shows schematically still another embodiment of an arrangement of photosites of a depth pixel;

FIG. 11 schematically shows still another embodiment of an arrangement of photosites of a depth pixel; and

FIG. 12 is a cross-section and perspective view illustrating an embodiment of a device for acquiring a 2D image and a depth image of a scene.

### DESCRIPTION OF EMBODIMENTS

Like features have been designated by like references in the various figures. In particular, the structural and/or functional features that are common among the various embodiments may have the same references and may dispose identical structural, dimensional and material properties.

For the sake of clarity, only the steps and elements that are useful for the understanding of the described embodiments have been illustrated and described in detail. In particular, the forming of the photosensitive elements, for example photodiodes, 2D image pixels, and depth pixels has not been detailed, the forming of such pixels being within the abilities of those skilled in the art based on the indications of the present disclosure.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following description, when reference is made to terms qualifying absolute positions, such as terms “edge”, “back”, “top”, “bottom”, “left”, “right”, etc., or relative positions, such as terms “above”, “under”, “upper”, “lower”, etc., or to terms qualifying directions, such as terms “horizontal”, “vertical”, etc., it is referred, unless specified otherwise, to the orientation of the drawings.

Unless specified otherwise, the expressions “about”, “approximately”, “substantially”, and “in the order of” signify plus or minus 10%, preferably of plus or minus 5%.

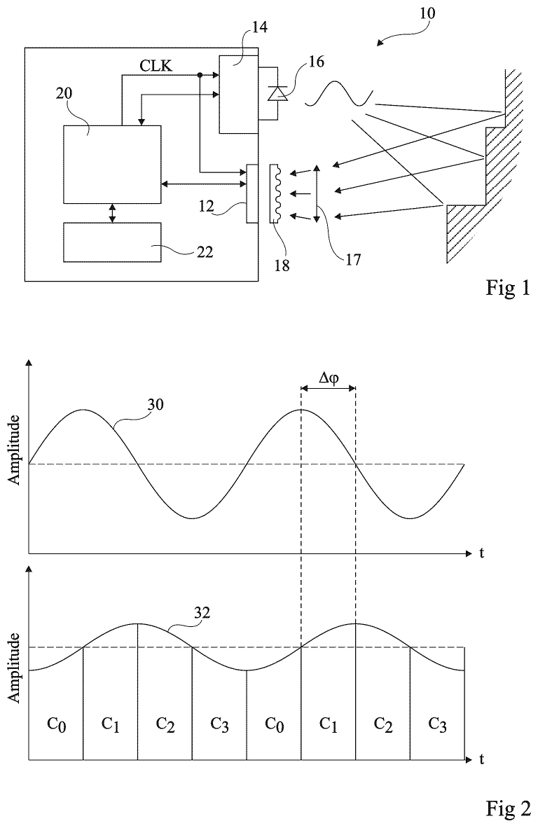

FIG. 1 schematically shows an embodiment of a depth imaging system 10 comprising a depth image acquisition device 12, or depth image sensor 12. System 10 comprises, for example, a light signal emission circuit 14 which drives a light source 16, for example a light-emitting diode (LED). Light-emitting diode 16 emits, for example, a light signal at a wavelength in the near-infrared spectrum, for example in the range from 700 nm to 1,100 nm. The light signal generated by light-emitting diode 16 is, for example, emitted towards the image scene via one or a plurality of lenses (not shown in FIG. 1). The light of the light signal reflected from the image scene is captured by sensor 12, for example via an imaging lens 17 and an array of microlenses 18, which focus the light onto the individual pixels of sensor 12.

Sensor 12 comprises, for example, a plurality of pixels capable of receiving the light signal reflected by the image scene and of detecting the phase of the received signal to form a depth image. These pixels are called depth pixels hereafter.

A processor 20 of imaging system 10 is, for example, coupled to sensor 12 and to the light signal emission circuit 14 and determines, based on the signals captured by the depth pixels of sensor 12, the corresponding distances of the objects in the image scene. The image or depth map generated by processor 20 is stored, for example, in a memory 22 of imaging system 10.

FIG. 2 is a graph showing, with a curve 30, an example of the time variation of the light intensity of the light signal emitted by light-emitting diode 16 towards the image scene, and, with a curve 32, an example of the time variation of the light intensity of the light signal received by one of the depth pixels of image acquisition device 12. Although, to simplify the comparison, these signals are shown in FIG. 2 as having the same intensity, in practice the light signal received by each depth pixel is likely to be significantly less intense than the emitted signal. In the example of FIG. 2, the light signal has the shape of a sine wave. However, in alternative embodiments, it may have a different periodic shape, for example formed of a sum of sinusoidal, triangular, or crenellated waves.

The depth pixels of the present disclosure are used to detect the phase of the received light signal. There is a phase shift Δφ between the transmitted light signal and the received light signal, which represents, modulo 2*H, the time of flight (“Time Of Flight”—ToF) of the light signal from light-emitting diode 16 to image acquisition device 12 via an object in the image scene which reflects the light signal. An estimate of the distance d to the object in the image scene can thus be calculated by using equation:

$$d = \frac{c}{4 π f} Δφ \qquad [ Math 1 ]$$

where c designates the speed of light, and f the frequency of the light signal, it being understood that, when the phase shift Δφ is determined modulo 2*Π, distance d is estimated with an uncertainty equal to (c*p)/(2*f), with p an integer.

The phase shift Δφ modulo 2*Π is for example estimated based on a sampling of the signal captured by a depth pixel during at least three distinct sampling windows, preferably during four distinct sampling windows, each corresponding to a different phase shift with respect to the emitted light signal, for example 0°, 90°, 180° and 270° for four sampling windows. As an example, the at least three sampling windows are implemented at each period of the light signal. A technique based on the detection of four samples per period is described in more detail in the publication by R. Lange and P. Seitz entitled “Solid-state TOF range camera”, IEE J. on Quantum Electronics, vol. 37, No. 3, March 2001.

The present embodiment is for example based on the detection of four samples per period. The samples of each sampling window are, for example, integrated over a large number of periods, for example over approximately 100,000 periods, or more generally between 10,000 and 10 million periods. Each sampling window has, for example, a duration of up to one quarter of the period of the light signal. These sampling windows are called C0, C1, C2, and C3 in FIG. 2, and, in the example of FIG. 2, each sampling window has a same duration and the four sampling windows have a total cycle time equal to the period of the light signal. More generally, there may or may not be a time interval separating one sampling window from the next one and, in certain cases, there could be an overlapping between sampling windows. Each sampling window for example has a duration in the range from 15% to 35% of the period of the light signal, in the case of a pixel capturing four samples per period.

The timing of sampling windows C0 to C3 is controlled in such a way as to be synchronized with the timing of the emitted light signal. For example, light signal emission circuit 14 generates a light signal based on a clock signal CLK (FIG. 1), and sensor 12 receives the same clock signal CLK to control the beginning and end time of each sampling window, for example using delay elements to introduce the appropriate phase shifts.

Based on the integrated samples of the light signal, and for a purely sinusoidal light wave, the phase shift Δφ y of the light signal can be determined, modulo 2*Π, that is, to within p*2*Π, by using the following equation:

$$Δφ = arctan ( \frac{{C}_{3} - {C}_{1}}{{C}_{0} - {C}_{2}} ) \qquad [ Math 2 ]$$

In certain embodiments, the frequency f of the light signal is 25 MHz, or more generally in the range from 10 MHz to 300 MHz.

In the rest of the disclosure, there is called “photosite” a single photodetector, or photosensitive element, and all the components enabling to acquire at least one sample of charges generated by absorption, by this photodetector, of the light signal reflected by the scene for which a depth image is desired. As an example, a photosite may be configured to enable to acquire a charge sample during a first sampling window during a first capture, and to enable to acquire another charge sample during a second sampling window during a second capture, the first and second windows then corresponding to two different phase shifts with respect to the emitted light signal.

Further, there is called “depth pixel” the assembly of components used to acquire all the samples required to determine a depth value. In particular, a depth pixel may comprise a plurality of photosites.

In conventional depth image sensors based on the capture of four samples, to determine the phase shift Δφ, modulo 2*Π between the emitted light signal and the light signal received by the depth pixel, the received light signal is sampled by successively transferring, at regular intervals, charges photogenerated in the photosensitive element of a photosite during first sampling window C0, charges photogenerated in the photosensitive element of the same or of another photosite during second sampling window C1, charges photogenerated in the photosensitive element of the same or of another photosite during third sampling window C2, and charges photogenerated in the photosensitive element of the same or of another photosite during third sampling window C3. In other words, in conventional sensors, each charge sample is delivered by a single photosite. Still in other words, in conventional sensors, for each charge sample, all the charges in the sample are photogenerated in a single photosensitive element.

Unlike conventional sensors where each charge sample used to determine the phase shift Δφ is delivered by a single photosite corresponding to this sample, in the described embodiments and variants, each charge sample photogenerated during a time window C0, C1, C2, or C3, and for example integrated over a large number of periods of the emitted signal, is delivered by a pair of photosites comprising a first photosite of a first detection level and a second photosite of a second detection level, the first detection level being stacked on the second detection level. In other words, each charge sample is delivered by a pair of photosites, the first photosite of which is arranged inside and on top of a first semiconductor substrate, and the second photosite of which is arranged inside and on top of a second semiconductor substrate, the first substrate being stacked on the first substrate, and the sample being simultaneously delivered by the two photosites.

The acquisition of a sample of charges photogenerated during a given sampling window in a pair of first and second photosites corresponds, for example, to the acquisition of a first sample of charges photogenerated during this sampling window in the first photosite of the pair of photosites, and to the simultaneous acquisition of a second sample of charges photogenerated during this same sampling window in the second photosite of the pair of photosites. In other words, a sample of charges photogenerated in a pair of photosites during a given sampling window, or time period, corresponds to the sum of the first and second samples of charges photogenerated during this time window respectively in the first and second photosites of this pair of photosites. Still in other words, the acquisition of a sample of charges photogenerated during a given time period in a pair of first and second photosites corresponds to the acquisition of charges photogenerated in the first photosite during this given time period and to the simultaneous acquisition of charges photogenerated in the second photosite during this same given time period.

Each pair of first and second photosites corresponds to a single “mean” photosite, which would detect a wave which is the average (in amplitude) of the incident wave seen by the first photosite of the pair of photosites and of the incident wave seen by the second photosite of this pair of photosites. Thus, conversely to the definition of a photosite given hereabove, this “mean” photosite comprises two distinct photosensitive elements. In other words, this “mean” photosite corresponds to a photosite comprising a single photosensitive element distributed over the two levels W1 and W2.

This “mean” photosite has the advantage of having a photosensitive volume greater than that of each of the first and second photosites which form this “mean” photosite, for example, a photosensitive volume doubled in the case where the photosensitive volume of the first photosite is identical to that of the second photosite. This results, for example, in an improvement in the sensitivity of the sensor without degrading its resolution and without increasing its surface area (in top view).

Further, due to the fact that each pair of photosites comprises first and second photosites respectively belonging to the first and second detection levels, this enables to avoid any potential problems of response dispersions between the two detection levels. As a result, the distance information reconstruction processes do not require using compensation or calibration steps between the two detection levels.

Thus, in the described embodiments and variants, to determine the phase shift Δφ between the emitted light signal and the light signal received by the depth pixel, the received light signal is sampled by transferring, successively and at regular intervals:
charges photogenerated during a first sampling window C0 in the photosensitive element of a first photosite and in the photosensitive element of a second photosite of a pair of photosites,
charges photogenerated during a second sampling window C1 in the photosensitive element of the first photosite and in the photosensitive element of the second photosite of the pair of photosites or of another pair of photosites,
charges photogenerated during a third sampling window C2 in the photosensitive element of the first photosite and in the photosensitive element of the second photosite of the pair of photosites or of another pair of photosites, and
charges photogenerated during a fourth sampling window C3 in the photosensitive element of the first photosite and in the photosensitive element of the second photosite of the pair of photosites or of another pair of photosites.

Each of the above four transfers is, for example, repeated a large number of times, for example 100,000 times, before a corresponding signal is read by an output circuit.

In the rest of the disclosure, to make the reading easier, a sampling window C0, C1, C2, or C3 and the charge sample photogenerated during this sampling window are designated with the same reference.

In the rest of the disclosure, the described embodiments and variants correspond to techniques based on the acquisition of four samples of photogenerated charges. However, techniques based on the acquisition of three samples of photogenerated charges are well known by those skilled in the art, who will be capable of adapting the description made for the case with four samples to the case with three samples, for example by removing all that relates to the acquisition of the fourth sample of photogenerated charges, by adapting the timing of the three remaining time windows, and by adapting formulas [Math 1] and [Math 2]. For example, in this case, the phase shifts between the three sampling windows and the emitted light signal are 0°, 120°, and 240° respectively, each sampling window having a duration of the order of one third of the period of the emitted light signal, for example equal to one third of the period of the emitted light signal.

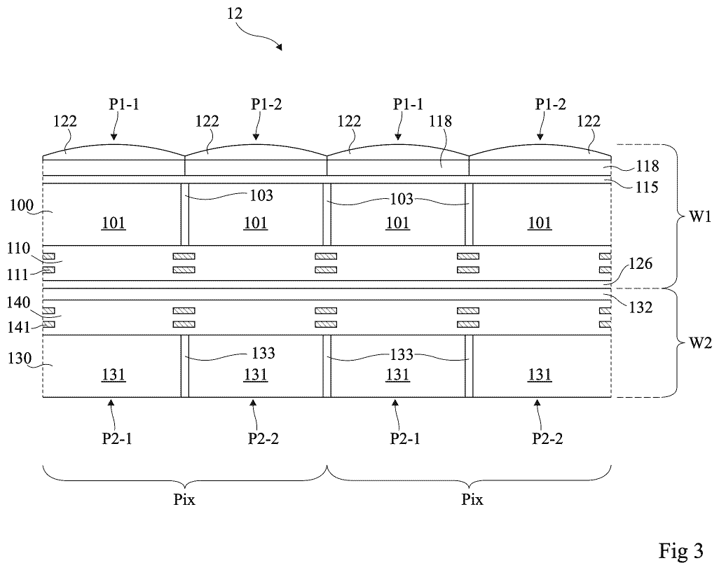

FIG. 3 is a cross-section view schematically and partially illustrating an embodiment of a device 12 for acquiring depth images of a scene. In FIG. 3, only two depth pixels Pix are shown although, in practice, device 12 comprises, for example, a number of depth pixels Pix much greater than two, for example greater than 100. Further, although this is not visible in FIG. 3, the pixels Pix of sensor 12 are preferably organized in an array of rows and of columns of pixels Pix.

The device 12 of FIG. 3 comprises:
a first detection level W1, also called first circuit W1, formed inside and on top of a first semiconductor substrate 100, for example a single-crystal silicon substrate; and
a second detection level W2, also called second circuit W2, formed inside and on top of a second semiconductor substrate 130, for example a single-crystal silicon substrate, detection level W1, and thus substrate 100, being stacked, or superimposed, on detection level W2, and thus substrate 130.

Throughout the rest of the disclosure, sensor 12 is configured so that the reflected light signal that it receives is first received by level W1 before being received by level W2, the light signal received by level W2 having first transited through level W1.

As an example, the thickness of each of substrates 100 and 130 is for example in the range from 2 μm to 10 μm, for example in the range from 3 μm to 5 μm.

It should be noted that, in the present description, it is respectively meant by front side and back side of a substrate the surface of the substrate coated with an interconnection stack and the surface of the substrate opposite to its front surface. In the embodiment of FIG. 3, the front and back sides of substrate 100 respectively are its lower surface and its upper surface, the front and back sides of substrate 130 respectively being its upper surface and its lower surface. Thus, in the example of FIG. 3, the front side of substrate 100, which is coated with an interconnection stack 110, is on the side of, or in front of, the front side of substrate 130, which is coated with an interconnection stack 140. Those skilled in the art are however capable of adapting the present disclosure to the case where the back sides of substrates 100 and 130 would face each other, or where the back side of one of substrates 100 and 130 would face the front side of the other of substrates 100 and 130. As an example, interconnection stack 110, respectively 140, is formed of alternated dielectric and conductive layers. Conductive tracks 111, respectively 141, and electric connection pads (not shown in FIG. 3) are formed in these conductive layers. Interconnection stack 110 further comprises conductive vias (not shown in FIG. 3) coupling tracks 111 to one another and/or to components formed in substrate 100 and/or to the electric connection pads of stack 110. Similarly, interconnection stack 140 comprises conductive vias (not shown in FIG. 3) coupling tracks 141 to one another and/or to components formed in substrate 140 and/or to the electric connection pads of stack 140.

Each pixel Pix is distributed between the two detection levels.

More particularly, each pixel Pix comprises N pairs Pi of photosites, with N an integer greater than or equal to 1, and i an integer ranging from 1 to N. To avoid overloading FIG. 3, the references Pi of the pairs Pi of photosites are not present in FIG. 3.

Each pair Pi of photosites comprises a first photosite P1-i of first level W1, and a second photosite P2-i of second level W2. Thus, each pair Pi of photosites of each pixel Pix is distributed over the two detection levels W1 and W2. Each pair Pi of photosites P1-i and P2-i enables to acquire a sample of charges photogenerated during a given sampling window in the photosites P1-i and P2-i of this pair of photosites, or a plurality of samples of charges photogenerated during a plurality of corresponding time windows.

In the example of FIG. 3, N is equal to 2, and each Pix pixel thus comprises:
a photosite P1-1 of level W1,
a photosite P1-2 of level W1,
a photosite P2-1 of level W2, and
a photosite P2-2 of level W2.

As an example, in FIG. 3, in each pixel Pix:
the pair P1 of photosites P1-1 and P2-1 of the pixel enables to acquire a sample C0 of charges photogenerated during a sampling window C0 in photosites P1-1 and P2-1;
the pair P1 of photosites P1-1 and P2-1 of the pixel enables to acquire a sample C2 of charges photogenerated during a sampling window C2 in photosites P1-1 and P2-1;
the pair P2 of photosites P1-2 and P2-2 of the pixel enables to acquire a sample C1 of charges photogenerated during a sampling window C1 in photosites P1-2 and P2-2; and
the pair P2 of photosites P1-2 and P2-2 of the pixel enables to acquire a sample C3 of charges photogenerated during a sampling window C3 in photosites P1-2 and P2-2.

Although this is not illustrated in FIG. 3, device 12 comprises a photosite control circuit configured to synchronize, in each pair Pi of photosites P1-i and P2-i, the operation of the photosite P1-i of pair Pi with the operation of the photosite P2-i of this pair Pi, so that the sampling window of the photosite P1-i of pair Pi is identical to, or, in other words, synchronized with, the sampling window of the photosite P2-i of this pair Pi. Delay elements may be provided to route the photosite control signals to one and or the other of levels W1 and W2 to ensure this synchronization between levels W1 and W2.

Level W1 comprises a plurality of depth photosites P1-i (P1-1 and P1-2 in FIG. 3), while level W2 comprises a plurality of depth photosites P2-i (P2-1 and P2-2 in FIG. 3). Preferably, all photosites P1-i are identical, all photosites P2-i are identical, and preferably, photosites P1-i and P2-i are identical. In the present description, two photosites are said to be identical, for example, when the circuit elements of a first one of the two photosites and the way in which the circuit elements of the first photosite are coupled and/or connected to each other, are identical, respectively, to the circuit elements of the second one of the two photosites and to the way in which the circuit elements of the second photosite are coupled and/or connected to each other, it being understood that the physical layout of the electric connections, that is, the metal lines implementing these electric connections, may be different in the two photosites. The circuit elements of two identical photosites may be controlled differently, for example with identical but phase-shifted control signals when these two identical photosites respectively correspond to two different sampling windows, or may be controlled identically and simultaneously, for example with identical and in-phase control signals, when these two photosites correspond to a same sampling window.

Each pixel Pix comprises as many photosites P1-i as photosites P2-i, that is, N photosites P1-i and N photosites P2-i. Preferably, in each pixel Pix, each photosite P1-i is stacked on a photosite P2-i of level W2, and more preferably on a photosite P2-i of said pixel Pix.

Although this is not shown in FIG. 3, interconnection stacks 110 and 140 connect the photosites P1-i of level W1 and the photosites P2-i of level W2 to a peripheral control and power supply circuit. This control circuit is configured to control the two photosites P1-i and P2-i of each pair of photosites Pi identically upon acquisition, by this pair Pi, of a sample of charges photogenerated during a given sampling window in the photosensitive elements 101 and 131 of its photosites P1-i and P2-i. As an example, the control circuit is synchronized with the emitted light signal, so that the timing of the sampling windows is synchronized with respect to the emitted light signal.

Preferably, in top view, photosites P1-i and P2-i all have photosensitive elements having a same surface area. For example, in top view, photosites P1-i and P2-i all have the same surface area. For example, in top view, the largest dimension of each photosite P1-i and of each photosite P2-i is smaller than 10 μm, for example smaller than 5 μm, for example smaller than 2 μm, for example in the order of 1 μm.

In the shown embodiment, in each pair Pi of photosites P1-i and P2-i, the photosite P1-i of this pair Pi is superimposed, or stacked, on the photosite P2-i of this same pair Pi. More particularly, in FIG. 3, in each pixel Pix, the photosite P1-1, respectively P1-2, of the pixel Pix is stacked on the photosite P2-1, respectively P2-2, of this pixel Pix.

As a variant, in each pixel Pix, the photosite P1-i of one pair Pi of the pixel Pix is stacked on the photosite P2-i of another pair Pi of this pixel Pix.

Preferably, although this is not visible in FIG. 3, photosites P1-i and P2-i are organized, or arranged, in rows and in columns. To say it in more detailed fashion, the photosites P1-i of level W1 are organized in rows and in columns of photosites P1-i and the photosites P2-i of level W2 are organized in rows and in columns of photosites P2-i, the rows, respectively columns, of photosites P1-i being stacked on the rows, respectively columns, of photosites P2-i. Each stack of a row of photosites P1-i and of a row of photosites P2-i forms a row of photosites P1-i, P2-i of sensor 12, each stack of a column of photosites P1-i and of a column of photosites P2-i forming a column of photosites P1-i, P2-i of sensor 12,

Preferably, and although this is not shown in FIG. 3, in each pixel Pix, when the photosites P1-i, P2-i of the pixel Pix are distributed over a plurality of rows of photosites P1-i, P2-i of sensor 12, these rows are successive rows and/or when the photosites P1-i, P2-i of the pixel Pix are distributed over a plurality of columns of photosites P1-i, P2-i of sensor 12, these columns are successive columns.

In the shown embodiment, level W1 comprises vertical insulating walls 103 crossing substrate 100 across its entire thickness and delimiting the substrate portions respectively corresponding to the photosites P1-i of level W1. Vertical insulating walls 103 have an optical isolation function, and may also have an electrical insulation function. As an example, vertical insulating walls 103 are made of a dielectric material, for example silicon oxide, or of a conductive material, such as polysilicon, covered with a dielectric material, such as silicon oxide, which electrically insulates it from substrate 100. As a variant, insulating walls 103 may not be present.

Similarly, in the shown embodiment, level W2 comprises vertical insulating walls 133 crossing substrate 130 across its entire thickness and delimiting the substrate portions respectively corresponding to the photosites P2-i of level W2. Vertical insulating walls 133 particularly have an optical isolation function, and may also have an electrical insulating function. As an example, vertical insulating walls 133 are made of a dielectric material, for example silicon oxide, or of a conductive material, for example polysilicon, covered with a dielectric material, for example silicon oxide, electrically insulating it from substrate 130. As a variant, insulating walls 133 may not be present.

As an example, the vertical insulating wall 133 surrounding each photosite P2-i is, for example, located substantially vertically in line with the vertical insulating wall 103 surrounding the photosite P1-i stacked on this photosite P2-i.

Each depth photosite P1-i comprises a photosensitive element 101, for example a photodiode, and each depth photosite P2-i comprises a photosensitive element 131, for example a photodiode. Each photodiode 101 is formed, or arranged, in the substrate 100 of level W1, each photodiode 131 being formed, or arranged, in the substrate 130 of level W2.

Due to the fact that each Pix pixel comprises as many photosites P1-i as photosites P2-i, each pixel Pix comprises as many photosensitive elements 101 as photosensitive elements 131.

In the present disclosure, when a photosite P1-i is stacked on a photosite P2-i, this preferably means that the photosensitive element 101 of photosite P1-i is stacked on the photosensitive element 131 of photosite P2-i, these two photosensitive elements 101 and 131 for example facing each other.

Each photosite P1-i, respectively P2-i, may further comprise one or a plurality of additional components (not shown), for example MOS (“Metal Oxide Semiconductor”) transistors, formed on the front side of substrate 100, respectively 130, for example inside and/or on top of substrate 100, respectively 130.

As an example, the side of substrate 100 intended to receive a light signal, that is, the back side of substrate 100 in the example of FIG. 3, is coated with a passivation layer 115, for example a silicon oxide layer, an HfO2 layer, an Al2O3 layer, or a stack of a plurality of layers of different materials which may have other functions than the passivation function only (antireflection, filtering, bonding, etc.), extending over substantially the entire surface of substrate 100. As an example, layer 115 is arranged on top of and in contact with substrate 100.

Preferably, as shown in FIG. 3, each photosite P1-i comprises a filter 118, for example a black resin layer or an interference filter, arranged on the side of substrate 100 intended to receive light, for example on top of and in contact with passivation layer 115, in front of the photosensitive element 101 of photosite P1-i. Each filter 118 is adapted to transmitting light in the emission wavelength range of light source 16 (FIG. 1). Preferably, filter 118 is adapted to only transmitting light in a relatively narrow waveband centered on the emission wavelength range of the light source 16 of system 10 (FIG. 1), for example a wavelength range having a width at half-maximum smaller than 30 nm, for example smaller than 20 nm, for example smaller than 10 nm. Filter 118 enables to prevent an unwanted generation of charge carriers in the photosensitive elements 101 and 131 of the underlying photosites P1-i and P2-i under the effect of a light radiation which does not originate from the light source 16 of system 10. According to an embodiment, there are no optical filters, particularly a color filter or an interference filter, interposed between detection level W1 and detection level W2.

Each photosite P1-i may further comprise a microlens 122 arranged on the side of substrate 100 intended to receive a light radiation, for example on top of and in contact with the filter 118 of the photosite, adapted to focusing the incident light onto the photosensitive element 101 of photosite P1-i and/or onto the photosensitive element 131 of the underlying photosite P2-i.

In the shown embodiment, the front side of sensor W1 is assembled to, or in other words rests on, the front side of sensor W2.

As an example, the two levels W1 and W2 stacked one on top of the other are assembled to each other by hybrid bonding. For this purpose, level W1 for example comprises a layer 126 entirely covering substrate 100 and being, in this example, interrupted by first electric connection elements, for example, vias or pads, and level W2 comprises, for example, a layer 132 of same nature as the layer 126 of level W1, layer 132 entirely covering substrate 130 and being, in this example, interrupted by second electric connection elements, for example vias or pads. The hybrid bonding is achieved by placing layer 130 into contact with layer 126, all over substrates 100 and 130, so that the first electric connection elements are in contact with the second electric connection elements.

For example, layers 126 and 132 are made of silicon oxide.

As a variant, a bonding material may be added between sensors W1 and W2 to allow the bonding of sensor W1 to sensor W2.

In the example of FIG. 3 where level W1 receives incident light from the back side of substrate 100 and level W2 receives incident light from the front side of substrate 130, the front sides of substrates 100 and 130 face each other, and layers 126 and 132 are respectively arranged on the front side of substrate 100 and on the front side of substrate 130. For example, layer 126 is arranged on top of and in contact with interconnection stack 110 and layer 132 is arranged on top of and in contact with interconnection stack 140.

As previously mentioned, the acquisition of a sample of charges photogenerated during a given sampling window Ci by a pair Pi of photosites P1-i, P2-i corresponds to the acquisition, by the photosite P1-i of pair Pi, of a first sample of charges photogenerated during this sampling window Ci in the photosensitive element 101 of this photosite P1-i, and to the simultaneous acquisition, by the photosite P2-i of this pair Pi, of a second sample of charges photogenerated during this same sampling window Ci in the photosensitive element 131 of this photosite P2-i, the first and second samples then being added to each other to obtain the sample of charges photogenerated during the sampling window by this pair Pi of photosites P1-i, P2-i.

For this purpose, although this is not shown in FIG. 3, sensor 12 includes means for adding, for each pair Pi of photosites P1-i, P2-i, the charge sample acquired by the photosite P1-i of pair Pi and the charge sample simultaneously acquired by the photosite P2-i of said pair Pi.

According to an embodiment, these means correspond, in each pair Pi of photosites P1-i, P2-i, to an electric connection between a sense node of the photosite P1-i of pair Pi and a corresponding sense node of the photosite P2-i of this pair Pi. As an example, this direct electric connection is at least partly implemented by conductive tracks 111 and 141 and/or the connection terminals of interconnection stacks 130 and 140, and by electric connections between these two interconnection stacks 130 and 140.

According to another embodiment, these means correspond, in each pair Pi of photosites P1-i, P2-i, to an electric connection between an output conductive line of the photosite P1-i of pair Pi and a corresponding output conductive line of the photosite P2-i of this pair Pi. As an example, this direct electrical connection is at least partly implemented by the conductive tracks 111 and 141 and/or the connection terminals of interconnection stacks 130 and 141. Preferably, when the photosites P1-i and P2-i of sensor 12 are arranged in rows and in columns, the output lines of photosites P1-i and P2-i are parallel to the columns and this connection is performed at the foot of a column.

According to still another embodiment, these means correspond to a digital processing circuit of sensor 12, for example processor 20 (FIG. 1), the processing circuit being configured to add, by digital processing, for each pair Pi of photosites P1-i, P2-i, the charges photogenerated in the photosensitive element 101 of the photosite P1-i of this pair Pi during a given time window and the charges photogenerated in the photosensitive element 131 of the photosite P2-i of this same pair Pi during the same time window.

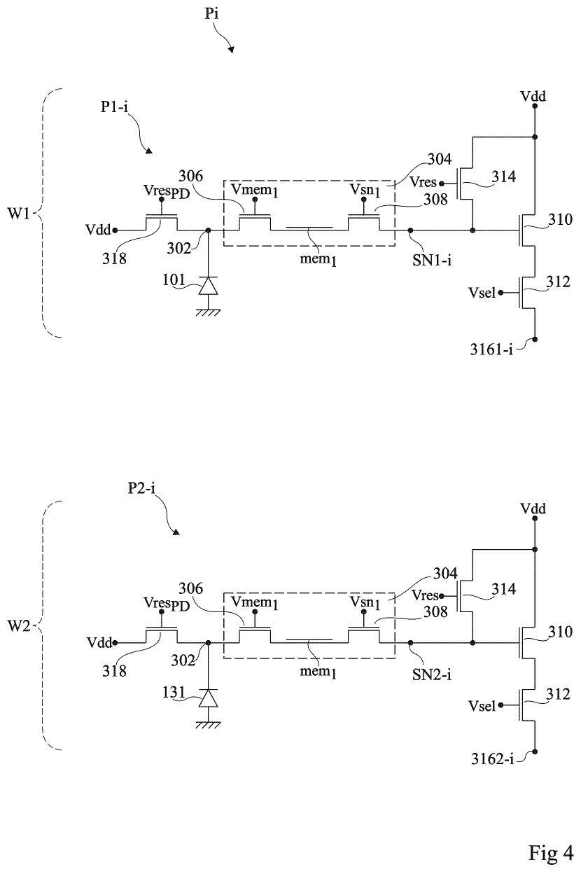

FIG. 4 is a circuit diagram illustrating an embodiment of a pair Pi of photosites P1-i and P2-i.

As described in relation with FIG. 3, the photosite P1-i of pair Pi belongs to detection level W1, the photosite P2-i of pair Pi belonging to detection level W2.

Each of the photosites P1-i and P2-i of pair Pi is capable of performing a charge storage, photosite P1-i being identical to photosite P2-i.

The photosite P1-i, respectively P2-i, of pair Pi comprises the photosensitive element 101, respectively 131, coupled between a node 302 and a reference power source, for example the ground, photosensitive element 101, respectively 131, for example being a photodiode. The node 302 of photosite P1-i is distinct from the node 302 of photosite P2-i.

The node 302 of photosite P1-i, respectively P2-i, is coupled to a sense node SN1-i, respectively SN2-i, via a sampling circuit 304 arranged inside and on top of substrate 100 (FIG. 3), respectively 130 (FIG. 3), of level W1, respectively W2.

Each sampling circuit 304 comprises a memory mem₁ coupled to node 302 by a transfer gate 306 which is, for example, an N-channel MOS transistor. The memory mem₁ of photosite P1-i, respectively P2-i, is also coupled to sense node SN1-i, respectively SN2-i, by an additional transfer gate 308, which is also, for example, an N-channel MOS transistor. In each circuit 304, transfer gate 306 is controlled by a signal Vmem₁ applied to its control node, and transfer gate 308 is controlled by a signal Vsn₁ applied to its control node. The memory mem₁ of photosite P1-i, respectively P2-i, provides a charge storage area where a charge transferred from photosensitive element 101, respectively 131, is temporarily stored.

The signals Vmem₁ and Vsn₁ delivered to the circuit 304 of the photosite P1-i of pair Pi are identical to those delivered to the circuit 304 of the photosite P2-i of this pair Pi, these signals being delivered, for example, by a control circuit, not shown.

Each photosite P1-i, P2-i further comprises an output circuit coupling node SN1-i, respectively SN2-i, to an output conductive line 3161-i, respectively 3162-i, of photosite P1-i, respectively P2-i. Each output circuit is formed of a source follower transistor 310, a selection transistor 312, and a reset transistor 314, these transistors for example being N-channel MOS transistors. In photosite P1-i, respectively P2-i, sense node SN1-i, respectively SN2-i, is coupled to the control node, or gate, of transistor 310, which has for example its drain coupled to power supply voltage source Vdd, and its source coupled to output line 3161-i, respectively 3162-i, by the transistor 312 which is controlled by a Vsel signal applied to its gate. In photosite P1-i, respectively P2-i, sense node SN1-i, respectively SN2-i, is also coupled to power supply voltage source Vdd through the transistor 314 of the photosite, which is controlled by a Vres signal applied to its gate.

The signals Vsel and Vres delivered to the circuit 304 of the photosite P1-i of pair Pi are identical to those delivered to the circuit 304 of the photosite P2-i of this pair Pi, these signals being delivered, for example, by a control circuit, not shown.

According to an embodiment, the node SN1-i of the photosite P1-i of pair Pi is connected to the node SN2-i of the photosite P2-i of pair Pi, which enables to add to one another the charge samples simultaneously acquired in each of the photosites P1-i and P2-i of pair Pi. As an example, the connection of node SN1-i to node SN2-i enables to add to one another, at the interconnected nodes SN1-i and SN2-i, the charges of the charge sample provided by photosite P1-i and the charges of the charge sample delivered by photosite P2-i, which results in an increase in the signal-to-noise ratio. In such an embodiment, preferably, photosites P1-i and P2-i share a single output circuit and a single output line, that is, the pair Pi of photosites P1-i and P2-i comprises a single output circuit and a single output line, shared by the two photosites P1-i and P2-i.

According to another embodiment, the output conductive line 3161-i of the photosite P1-i of pair Pi is connected to the output conductive line 3162-i of the photosite P2-i of pair Pi, which enables to add to one another the charge samples simultaneously acquired in each of the photosites P1-i and P2-i of pair Pi. As an example, in this embodiment, the voltage on the interconnected lines 3161-i and 3162-i corresponds to an average, to within a constant relative to follower transistors 310, of the voltage which would be present on line 3161-i if it was decoupled from line 3162-i, and of the voltage which would be present on line 3162-i if it was decoupled from line 3161-i, this average voltage thus being representative of the sum of the charges of the charge sample delivered by photosite P1-i and of the charges of the charge sample delivered by photosite P2-i.

According to still another embodiment, the charges of the charge samples simultaneously acquired in each of the photosites P1-i and P2-i of pair Pi are added to one another by digital processing. This digital processing is, for example, implemented by a digital processing circuit receiving, for example, a digital signal representative of an analog output signal delivered by line 3161-i, and thus of the charges of the charge sample delivered by photosite P1-i, and a digital signal representative of an analog output signal delivered by line 3162-i, and thus of the charges of the charge sample delivered by photosite P2-i.

Photosite P1-i, respectively P2-i, further comprises, for example, a transistor 318 coupling the node 302 of the photosite to power supply voltage source Vdd and enabling photodiode 101, respectively 131, to be reset. Each transistor 318 is for example controlled by a same signal Vres_{PD}, for example delivered by a control circuit, not shown. It thus enables to control the exposure time by emptying photodiode 101, respectively 131, before the beginning of an integration, and to ensure an anti-blooming function to prevent an overflowing of the photodiode into memories mem₁ during the reading.

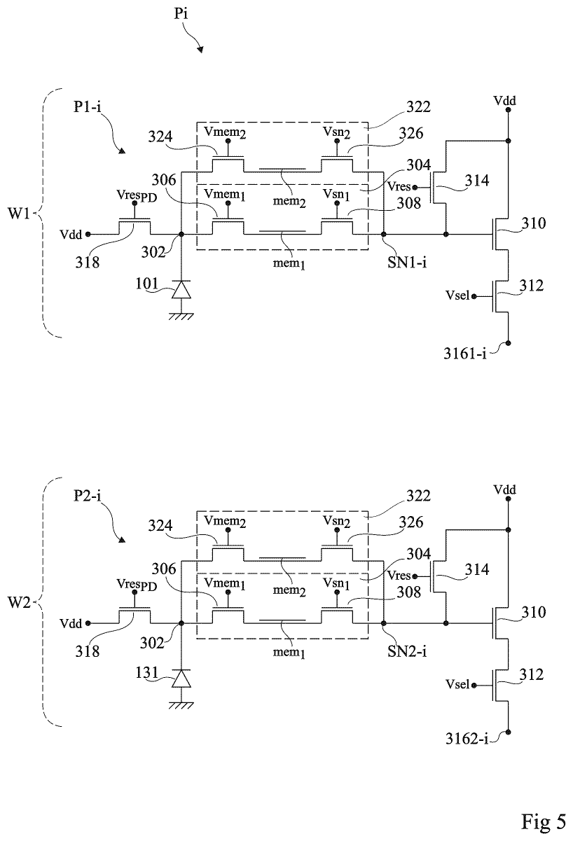

FIG. 5 is a circuit diagram illustrating another embodiment of a pair Pi of photosites P1-i and P2-i.

As described in relation with FIG. 3, the photosite P1-i of pair Pi belongs to detection level W1, the photosite P2-i of pair Pi belonging to detection level W2. Photosite P1-i is identical to photosite P2-i.

The pair Pi of photosites P1-i, P2-i in FIG. 5 comprises all the elements of the pair Pi of photosites P1-i, P2-i of FIG. 4. Further, in FIG. 5, the photosite P1-i, respectively P2-i, of pair Pi comprises another sampling circuit 322 connected between node 302 and node SN1-i, respectively SN2-i. Each circuit 322 comprises circuit elements similar to the circuit elements of sampling circuit 304. In particular, each circuit 322 comprises a memory mem₂, a transfer gate 324 controlled by a signal Vmem₂, and a transfer gate 326 controlled by a signal Vsn₂.

As previously, the two photosites P1-i and P2-i of pair Pi are simultaneously and identically controlled, and thus receive the same control signals Vsel, Vres, Vres_{PD}, Vmem₁, Vsn₁, Vmem₂, and Vsn₂.

The pair Pi of FIG. 5 enables to acquire two samples for one depth image.

The reading from the two memories mem₁ of pair Pi and from the two memories mem₂ is sequentially performed, for example, by first reading from the two memories mem₁ and then from the two memories mem₁, or vice versa.

A circuit similar to the circuit of each of the photosites P1-i and P2-i of pair Pi is described in further detail in French patent application bearing application number FR 15/63457 (attorney reference: B14596). For example, a timing diagram illustrating an example of operation of this circuit is shown in FIG. 3 of application FR 15/63457, and the same example of operation applies in the context of the present application.

According to an embodiment, similarly to what has been described in relation with FIG. 4, to add together the charge samples simultaneously acquired in each of the photosites P1-i and P2-i of pair Pi, the node SN1-i of the photosite P1-i of pair Pi is connected to the node SN2-i of the photosite P2-i of pair Pi, or the output conductive line 3161-i of the photosite P1-i of pair Pi is connected to the output conductive line 3162-i of the photosite P2-i of pair Pi, or this operation is performed by digital processing by a digital processing circuit.

As indicated in relation to FIG. 4, when the sense nodes SN1-i and SN2-i of the photosites P1-i and P2-i of pair Pi are connected together, preferably photosites P1-i and P2-i share a common output circuit and a common output line.

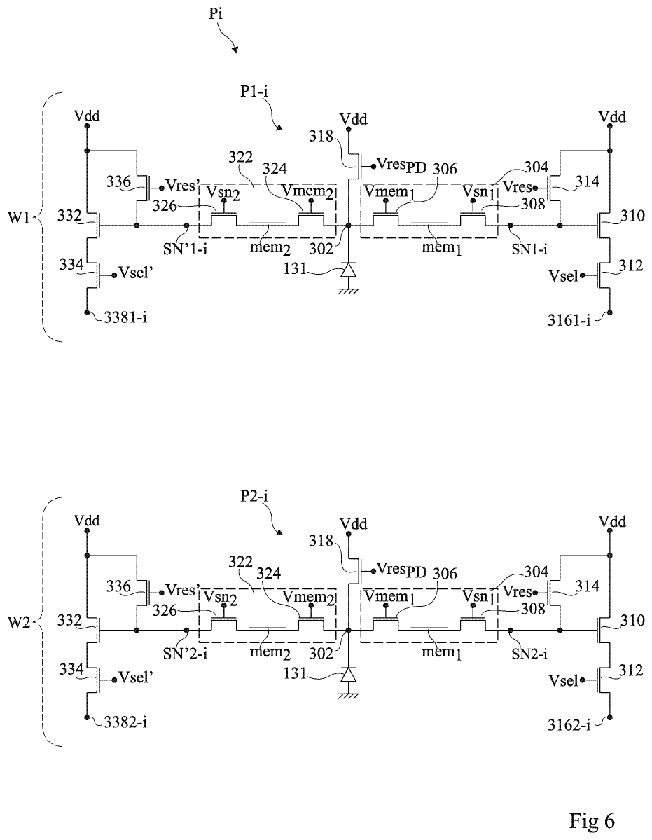

FIG. 6 is a circuit diagram illustrating still another embodiment of a pair Pi of photosites P1-i and P2-i.

As described in relation with FIG. 3, the photosite P1-i of pair Pi belongs to detection level W1, the photosite P2-i of pair Pi belonging to detection level W2. Photosite P1-i is identical to photosite P2-i.

The pair Pi of FIG. 6 comprises the general pair Pi shown in FIG. 5, with the difference that the sampling circuit 322 of photosite P1-i, respectively P2-i, is connected between the node 302 of the photosite and a node SN′l-i, respectively SN′2-i. Further, photosite P1-i, respectively P2-i, comprises an additional output circuit coupling node SN′l-i, respectively SN′2-i, to an output conductive line 3381-i, respectively 3382-i, of photosite P1-i, respectively P2-i. Each additional output circuit is formed of a source-follower transistor 332, of a selection transistor 334, and of a reset transistor 336, these transistors being N-channel MOS transistors, for example. In photosite P1-i, respectively P2-i, sense node SN′l-i, respectively SN′2-i, is coupled to the control node of transistor 332, which has for example its drain coupled to power supply voltage source Vdd, and its source coupled to the output line 3381-i, respectively 3382-i, by transistor 334, which is controlled by a signal Vsel′ applied to its gate. In photosite P1-i, respectively P2-i, sense node SN′l-i, respectively SN′2-i, is also coupled to power supply voltage source Vdd through the transistor 336 of the photosite, which is controlled by a signal Vres' applied to its gate.

As previously, the two photosites P1-i and P2-i of pair Pi are simultaneously and identically controlled, and thus receive the same control signals.

The pair Pi of FIG. 6 enables to acquire two samples for one depth image.

The reading from the two memories mem₁ of pair Pi and from the two memories mem₂ may be performed simultaneously.

According to an embodiment, similarly to what has been described in relation with FIG. 4, the node SN1-i of the photosite P1-i of pair Pi is connected to the node SN2-i of the photosite P2-i of pair Pi, and the node SN1-i of the photosite P1-i of pair Pi is connected to the node SN2-i of the P2-i photosite of pair Pi, and the node SN′1-i of the photosite P1-i of pair Pi is connected to the node SN′2-i of the photosite P2-i of pair Pi, which enables to add to one another the charges of the charge samples simultaneously acquired in each of the photosites P1-i and P2-i of pair Pi. In such an embodiment, although this is not the case in FIG. 6, preferably, photosites P1-i and P2-i share their output circuits and their output conductive lines, similarly to what has been indicated in relation with FIG. 4.

According to another embodiment, similarly to what has been described in relation with FIG. 4, the output conductive line 3161-i of the photosite P1-i of pair Pi is connected to the output conductive line 3162-i of the photosite P2-i of pair Pi, and the output conductive line 3381-i of the photosite P1-i of pair Pi is connected to the output conductive line 3382-i of the photosite P2-i of pair Pi, which enables to add to one another the charges of the charge samples simultaneously acquired in each of the photosites P1-i and P2-i of pair Pi, or, in other words, which enables to obtain an average voltage representative of the sum of these photogenerated charges.

According to still another embodiment, similarly to what has been described in relation with FIG. 4, the charge samples simultaneously acquired in each of the photosites P1-i and P2-i of pair Pi are added together by digital processing, for example by a digital processing circuit receiving, for example, a digital signal representative of an analog output signal delivered by line 3161-i, a digital signal representative of an analog output signal delivered by line 3162-i, a analog signal representative of an analog signal delivered by line 3381-i, and a digital signal representative of an analog signal delivered by line 3382-i.

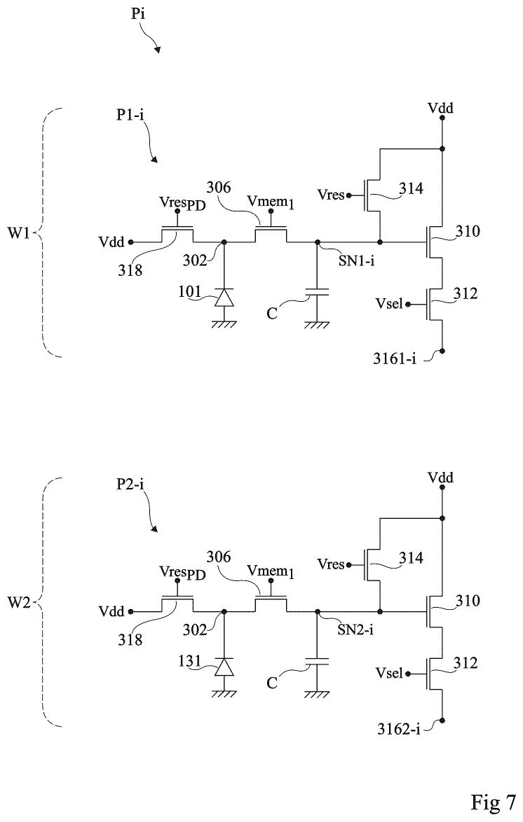

FIG. 7 is a circuit diagram illustrating still another embodiment of a pair Pi of photosites P1-i and P2-i.

As described in relation with FIG. 3, the photosite P1-i of pair Pi belongs to detection level W1, the photosite P2-i of pair Pi belonging to detection level W2. Photosite P1-i is identical to photosite P2-i.

The pair Pi of photosites P1-i and P2-i of FIG. 7 comprises all the elements of the pair Pi shown in FIG. 4, with the difference that transistors 308 and memories mem₁ are not present. Further, in photosite P1-i, respectively P2-i, transistor 306 is directly connected to sense node SN1-i, respectively SN2-i. In other words, in each photosite P1-i, P2-i, the sampling circuit is formed of transistor 306 alone.

In this embodiment, in photosite P1-i, respectively P2-i, the charges are stored directly on sense node SN1-i, respectively SN2-i. There is no intermediate storage, and sense node SN1-i or SN2-i is used as a memory for photosite P1-i or P2-i. It is spoken in this case of a voltage storage. A capacitor C may be added to each sense node SN1-i, SN2-i, connected between the sense node and the ground, to increase the dynamic range. The storage capacity of each sense node SN1-i, SN2-i may also be only formed by intrinsic capacitances present on the sense node, for example by the sum of the gate capacitance of the transistor 310 connected to this node, of the source capacitance of the transistor 314 connected to this node, of the drain capacitance of the transistor 306 connected to this node, and of the equivalent capacitance between the electric connection wires coupling the nodes SN1-i and SN2-i and the wires of adjacent electric connections.

The cases of voltage photosites enabling to acquire two samples, in parallel or sequential reading, can be easily derived from the charge photosites previously discussed in relation with FIGS. 5 and 6, by removing transistors 308 and 326 and, for example, by replacing each memory mem₁ and mem₂ with a capacitive element. Further, the cases of voltage or charge photosites enabling to acquire more than two samples, in parallel or sequential reading, can easily be derived from the photosites described in relation to FIGS. 5, 6, and 7.

According to an embodiment, each pixel Pix (FIG. 3) comprises at least one pair Pi of photosites P1-i and P2-i for acquiring the samples necessary to determine a depth data element, for example three samples C0, C1, and C2, preferably four samples C0, C1, C2, and C3.

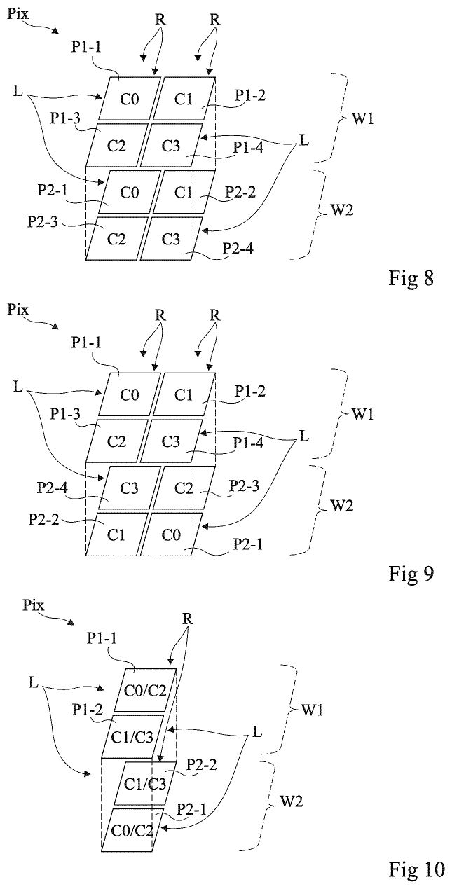

FIGS. 8, 9, 10, and 11 each show schematically an embodiment of an arrangement of photosites of a depth pixel Pix.

In these embodiments, the sensor only comprises depth pixels Pix for the determination of a depth image. In order not to overload the drawings, a single pixel Pix is shown therein, the other pixels Pix of the sensor being identical to that described.

Further, as previously indicated, the photosites P1-i and P2-i of pixels Pix are organized into rows L and columns R, each row L corresponding to the stacking of a row of photosites P2-i of level W2 and of a row of photosites P1-i of level W1, and each column R corresponding to the stacking of a column of photosites P2-i of level W2 and of a column of photosites P1-i of level W1. In this embodiment where the sensor only comprises depth pixels Pix, preferably, the rows L of photosites are adjacent two by two, and the columns R of pixels are adjacent two by two.

In the embodiment of FIG. 8, each pixel Pix comprises N equal 4 pairs Pi of photosites P1-i and P2-i, and each pair Pi of photosites P1-i, P2-i is configured to acquire a single charge sample. For example, the pair P1 (not referenced in FIG. 8) of photosites P1-1 and P2-1 is configured to acquire sample C0, the pair P2 (not referenced in FIG. 8) of photosites P1-2 and P2-2 is configured to acquire sample C1, the pair P3 (not referenced in FIG. 8) of photosites P1-3 and P2-3 is configured to acquire sample C2, and the pair P4 (not referenced in FIG. 8) of photosites P1-4 and P2-4 is configured to acquire sample C3.

In the embodiment of FIG. 8, in each pair Pi of photosites P1-i and P2-i, photosite P1-i is stacked on photosite P2-i. Thus, in FIG. 8, photosites P1-1, P1-2, P1-3, and P1-4 are stacked on respective photosites P2-1, P2-2, P2-3, and P2-4.

In this embodiment, the four samples C0, C1, C2, and C3 are captured in a single image or capture.

In the embodiment of FIG. 9, pixel Pix is identical to that shown in FIG. 8, with the difference that, in each pair Pi of photosites P1-i and P2-i, photosite P1-i is offset by one row L and by one column R with respect to photosite P2-i.

From the point of view of the sensor, this enables to divide by two the spatial repetition step in the direction of rows L and by two the spatial repetition step in the direction of columns R of the photosites configured to acquire a same charge sample C0, C1, C2, or C3. The result is an improvement in the spatial accuracy of each pixel, and thus in the spatial accuracy of the depth image obtained with the sensor.

In the example illustrated in FIG. 9, in level W1, photosites P1-1 and P1-2 belong to the same first row L, photosites P1-3 and P1-4 belong to the same second row L adjacent to the first row L, photosites P1-1 and P1-3 further belonging to the same first column R and photosites P1-2 and P1-4 further belonging to the same second column R adjacent to the first column R. Further, photosite P1-1 is stacked on photosite P2-4, photosite P1-2 is stacked on photosite P2-3, photosite P1-3 is stacked on photosite P2-2, and photosite P1-4 is stacked on photosite P2-1.

Although in the example of FIG. 9, in each pair Pi of photosites P1-i and P2-i, photosite P1-i is offset by one row L and by one column R with respect to photosite P2-i, the cases where photosite P1-i is only offset by one row L with respect to photosite P2-i, and where photosite P1-i is only offset by one column R with respect to photosite P2-i, are within the abilities of those skilled in the art based on the description made in relation with FIG. 9.

In the embodiment of FIG. 10, each Pix pixel comprises N equal 2 pairs Pi of photosites P1-i and P2-i, and each pair Pi of photosites P1-i, P2-i is configured to enable to acquire two charge samples, in a single image or capture. In other words, each photosite P1-i, P2-i comprises two memories. For example, the pair P1 (not referenced in FIG. 10) of photosites P1-1 and P2-1 is configured to acquire sample C0 and sample C2 (designated with reference C0/C2 in FIG. 10), the pair P2 (not referenced in FIG. 10) of photosites P1-2 and P2-2 being configured to acquire sample C1 and sample C3 (designated with reference C1/C3 in FIG. 10).

In the embodiment of FIG. 10, all the photosites P1-i and P2-i of pixel Pix belong to the same column R. Further, in each pair Pi of photosites P1-i and P2-i, the photosite P1-i of pair Pi is offset by one row L with respect to the photosite P2-i of this pair Pi, to obtain a depth image of improved accuracy.

More specifically, in the example of FIG. 10, photosite P1-1 is stacked on photosite P2-2 and photosite P1-2 is stacked on photosite P2-1.

As a variant not shown, in each pair Pi of photosites P1-i and P2-i, the photosite P1-i of pair Pi can be stacked on the photosite P2-i of this pair Pi.

The alternative embodiment where the photosites P1-i and P2-i of pixel Pix all belong to the same row L and, in each pair Pi, the photosite P1-i of pair Pi is offset by one column R with respect to the photosite P2-i of this pair Pi, is within the abilities of those skilled in the art based on the description made in relation with FIG. 10. Further, the alternative embodiment where the photosites P1-i and P2-i of pixel Pix all belong to the same row L and, in each pair Pi, the photosite P1-i of pair Pi is stacked on the photosite P2-i of this pair Pi, is within the abilities of those skilled in the art.

Those skilled in the art are also capable of adapting the embodiments and variants described hereabove in relation with FIG. 10 to the cases where each photosite P1-i, P2-i is configured to acquire more than two samples, for example three or four samples, per image or capture, that is, to the case where each photosite comprises more than two memories, for example respectively three or four memories.

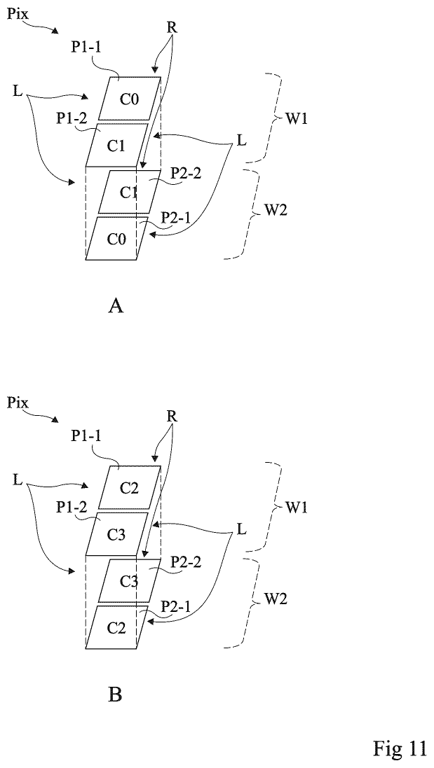

In the embodiment of FIG. 11, each pixel Pix comprises N equal 2 pairs Pi of photosites P1-i and P2-i, and each pair Pi of photosites P1-i, P2-i is configured to enable to acquire a charge sample during a first image or capture, and a second charge sample during a second image or capture implemented after the first image or capture. In other words, each photosite P1-i, P2-i comprises a single memory.

More particularly, in the example of FIG. 11, the pair P1 (not referenced in FIG. 11) of photosites P1-1 and P2-1 is configured to acquire sample C0 during a first capture A (at the top in FIG. 11) and sample C2 during a second capture B (at the bottom in FIG. 11), the pair P2 (not referenced in FIG. 10) of photosites P1-2 and P2-2 being configured to acquire sample C1 during the first capture A and sample C3 during the second capture B.

In the embodiment of FIG. 11, all the photosites P1-i and P2-i of pixel Pix belong to the same column R. Further, in each pair Pi of photosites P1-i and P2-i, the photosite P1-i of pair Pi is offset by one row L with respect to the photosite P2-i of this pair Pi, to obtain a depth image of increased spatial accuracy.

More particularly, in the example shown in FIG. 11, photosite P1-1 is stacked on photosite P2-2 and photosite P1-2 is stacked on photosite P2-1.

As a variant not shown, in each pair Pi of photosites P1-i and P2-i, the photosite P1-i of pair Pi may be stacked on the photosite P2-i of this pair Pi.

The alternative embodiment where the photosites P1-i and P2-i of pixel Pix all belong to the same row L and, in each pair Pi, the photosite P1-i of pair Pi is offset by one column R with respect to the photosite P2-i of this pair Pi, is within the abilities of those skilled in the art based on the description made in relation with FIG. 11. Further, the embodiment where the photosites P1-i and P2-i of pixel Pix all belong to the same row L and, in each pair Pi, the photosite P1-i of pair Pi is stacked on the photosite P2-i of this pair Pi, is within the abilities of those skilled in the art.

In addition to acquiring a depth image, the acquisition device 12 of the system 10 shown in FIG. 1 may be capable of acquiring a 2D image.

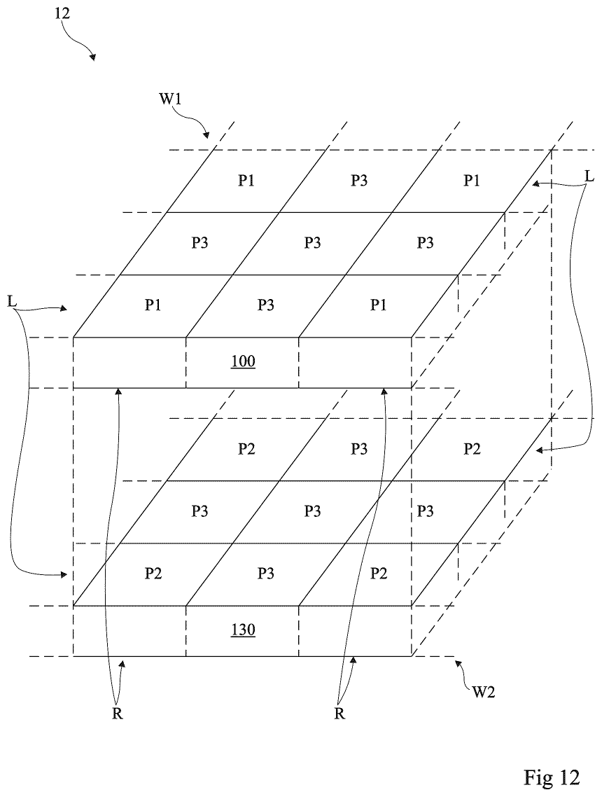

FIG. 12 is a cross-section and perspective view schematically and partially illustrating an embodiment of a device 12 for acquiring a 2D image and a depth image of a scene.

In FIG. 12, only the substrate 100 of detection level W1 and the substrate 130 of detection level W2 are shown, and, further, all the photosites P1-I, respectively P2-i of level W1, respectively W2, have the same reference P1, respectively P2.

As compared with the previously described embodiments and variants where sensor 12 only comprises depth pixels Pix, in the embodiment of FIG. 12, sensor 12 further comprises 2D image pixels designated with reference P3. Preferably, as illustrated in FIG. 12, pixels P3 are arranged inside and on top of substrate 100 and pixels P3 are arranged inside and on top of substrate 130. In variants not shown, pixels P3 are all arranged inside and on top of substrate 100, or all arranged inside and on top of substrate 130.

Further, as compared with the previously described embodiments and variants where two successive columns R of depth photosites P1-i, P2-i are adjacent and where two successive rows L of depth photosites P1-i, P2-i are adjacent, in the present embodiment, rows of pixels P3 are interposed between each two successive rows L, and columns of pixels P3 are interposed between each two successive columns R.

Each pixel P3 is adapted to measuring a light intensity in a given range of visible wavelengths. For this purpose, and although this is not detailed in FIG. 12, each pixel P3 comprises a photosensitive element, for example a photodiode, formed in the substrate 100 or 130 of the level W1 or W2, respectively, to which this pixel P3 belongs.

Preferably, sensor 12 is configured to acquire a 2D color image. In this case, pixels P3 are of different types, each type of pixel P3 being adapted to measuring a light intensity in a given range of visible wavelengths, distinct from those of the other types of pixels P3. Each pixel P3 then comprises a color filter, for example made of a colored resin, facing the photodiode of pixel P3, the filter being configured to only transmit the wavelengths of light belonging to the wavelength range for which pixel P3 measures the light intensity.

In the case of the embodiment of FIG. 12 where each level W1 and W2 comprises pixels P3, preferably two pixels P3 stacked one on top of the other share a same color filter, and the color filter rests on substrate 100, which receives the incident light before substrate 130, and, more particularly, on the side of substrate 100 which receives the incident light. As a variant, each pixel P3 may have its own color filter, the latter resting on the substrate 100 or 130 having pixel P3 formed inside and on top of it, on the side of this substrate 100 or 300 which receives the incident light.

In another embodiment, not illustrated, only level W1 comprises pixels P3. In this case, the color filter of each P3 pixel rests on substrate 100, on the side of substrate 100 which receives the incident light.

In still another embodiment, not illustrated, only level W2 comprises pixels P3. In this case, the color filter of each pixel P3 rests on substrate 130, on the side of substrate 130 which receives the incident light. As a variant, the color filter of each pixel P3 rests on substrate 100, on the side of substrate 100 which receives the incident light.

As an example, sensor 12 comprises three types of pixels P3, first pixels P3 called blue pixels, comprising a color filter preferentially transmitting blue light, second pixels P3 called red pixels, comprising a color filter preferentially transmitting red light, and third pixels P3 called green pixels, comprising a color filter preferentially transmitting green light. In FIG. 12, the different types of P3 pixels are not differentiated.

As a variant, sensor 12 is configured to capture a monochromatic 2D image, in which case the color filters of pixels P3 may be omitted.

Those skilled in the art are capable of adapting the description made in relation with FIGS. 8 to 11 in the case where rows L are adjacent two by two and columns R are adjacent two by two, to the case of FIG. 12 where each two successive lines L are separated from each other by one or a plurality of rows of pixels P3, and each two successive columns R are separated from each other by one or a plurality columns of pixels P3. In other words, those skilled in the art are capable of adapting this description to the case where each row L is separated from a next row L by one or a plurality of rows of pixels P3, and each column R is separated from a next column R by one or a plurality of columns of pixels P3.

Various embodiments and variants have been described. Those skilled in the art will understand that certain features of these various embodiments and variants may be combined, and other variants will occur to those skilled in the art.

In particular, those skilled in the art are capable of adapting the embodiments and variants described in the case where the phase shift Δφ is obtained based on four charge samples C0, C1, C2, and C3 corresponding to four different sampling windows to the case where the phase shift Δφ is obtained based on three charge samples C0, C1, and C2 corresponding to three different sampling windows, each corresponding to a different phase shift with respect to the emitted light signal, for example 0°, 120° and 240°. In this case, each sampling window has, for example, the same duration and the three sampling windows have a total cycle time equal to the period of the light signal.

Further, although there have been described hereabove embodiments and variants where, in each pixel Pix, each of the photosites P1-i of the pixel Pix is stacked on a photosite P2-i of this pixel Pix, those skilled in the art are capable of adapting these embodiments and variants to the cases where, in each pixel Pix, one or a plurality of photosites P1-i are each stacked on a photosite P2-i of a neighboring pixel Pix, and one or a plurality of photosites P2-i of pixel Pix are each topped with a photosite P1-i of a neighboring pixel Pix. This case corresponds, for example, to the case where two identical sensors, each implemented on a single detection level, are assembled to form a device 12, after having been offset from one each other by one row and/or one by column of photosites.

Finally, the practical implementation of the described embodiments and variants is within the abilities of those skilled in the art based on the functional indications given hereabove.

1. Sensor of a reflected light signal corresponding to the reflection on a scene of a periodically amplitude-modulated incident light signal for acquiring a depth map of the scene, the sensor comprising depth pixels, wherein:
each depth pixel comprises at least one pair of photosites, each photosite corresponding to a single photosensitive element and an assembly of components enabling to acquire at least one sample of charges photogenerated by absorption by this photosensitive element of the reflected light signal;
each pair of photosites comprises a first photosite comprising a first photosensitive element arranged in a first semiconductor substrate and a second photosite comprising a second photosensitive element arranged in a second semiconductor substrate having the first semiconductor substrate stacked thereon; and
each depth pixel is configured to acquire:
at least one first sample of charges photogenerated in the first and second photosensitive elements of a first pair of photosites of said pixel by detection of the light signal reflected during first time periods;
at least one second sample of charges photogenerated in the first and second photosensitive elements of a second pair of photosites of said pixel by detection of the light signal reflected during second time periods offset with respect to the first time periods by a first constant phase shift; and
at least one third sample of charges photogenerated in the first and second photosensitive elements of a third pair of photosites of said pixel by detection of the light signal reflected during third time periods offset with respect to the first time periods by a second constant phase shift different from the first phase shift,
wherein the acquisition of a sample of charges photogenerated during a given time period in a pair of first and second photosites corresponds to the acquisition of the charges photogenerated in the first photosite during said given time period and to the simultaneous acquisition of the charges photogenerated in the second photosite during the same given time period.

2. Sensor according to claim 1, wherein each first photosensitive element of each depth pixel is stacked on a second photosensitive element preferably of said pixel.

3. Sensor according to claim 1, wherein each depth pixel comprises as many first photosensitive elements as second photosensitive elements.

4. Sensor according to claim 1, wherein, in each depth pixel, the first and third pairs of photosites have a same first photosite and a same second photosite.

5. Sensor according to claim 1, wherein each depth pixel is further configured to acquire at least a fourth sample of charges photogenerated in the first and second photosensitive elements of a fourth pair of photosites of said pixel by detection of the light signal reflected during fourth time periods offset with respect to the first time periods by a third constant phase shift different from the first and second phase shifts.

6. Sensor according to claim 4, wherein, in each depth pixel, the second and fourth pairs of photosites have a same first photosite and a same second photosite.

7. Sensor according to claim 1, wherein, in each pair of photosites of each depth pixel, the first photosensitive element of the first photosite of said pair is stacked on the second photosensitive element of the second photosite of said pair.

8. Sensor according to claim 1, wherein:
the first and second photosites of the depth pixels are organized in rows and in columns; and
in each depth pixel, the first photosite of each pair of photosites of said pixel is offset by one row and/or by one column with respect to the second photosite of said pair of photosites.

9. Sensor according to claim 1, wherein:
each first photosite comprises a first node and at least one first sampling circuit arranged inside and on top of the first substrate and coupling the first node to the first photosensitive element of the first photosite; and
each second photosite comprises a second node and at least one second sampling circuit arranged inside and on top of the second substrate and coupling the second node to the second photosensitive element of the second photosite.

10. Sensor according to claim 9, wherein:
each first photosite comprises a first output circuit coupling the first node of the first photosite to a first output line of the first photosite; and
each second photosite comprises a second output circuit coupling the second node of the second photosite to a second output line of the second photosite.

11. Sensor according to claim 9, wherein, in each pair of photosites, the second node of the second photosite is directly connected to the first node of the first photosite.

12. Sensor according to claim 10, wherein, in each pair of photosites, the first output line of the first photosite is directly connected to the second output line of the second photosite.

13. Sensor according to claim 10, wherein the sensor comprises a digital processing circuit configured to add, by digital processing, for each pair of photosites, the charges photogenerated in the first photosensitive element of the first photosite of said pair and the charges photogenerated in the second photosensitive element of the second photosite of said pair.

14. Sensor according to claim 1, wherein the sensor further comprises 2D image pixels arranged on top and inside of one and/or other of the first and second substrates.

15. Sensor according to claim 1, further comprising a control circuit configured, for each pair of photosites of each pixel, to identically and simultaneously control the first and second photosites of said pair of photosites.

16. System for acquiring a depth image comprising the sensor according to claim 1, a light source configured to periodically emit the amplitude-modulated incident light signal, and a processor configured to determine, based on the first, second, and third samples, a phase shift between the incident light signal and the reflected light signal.

17. Acquisition system according to claim 16, wherein each depth pixel is further configured to acquire at least a fourth sample of charges photogenerated in the first and second photosensitive elements of a fourth pair of photosites of said pixel by detection of the light signal reflected during fourth time periods offset with respect to the first time periods by a third constant phase shift different from the first and second phase shifts and wherein the processor (20) is configured to determine, based on the first, second, third, and fourth samples, the phase shift between the incident light signal and the reflected light signal.
